(19) United States
(12) Patent Application Publication
(10) Pub. No.: US 2006/0191261 A1
(43) Pub. Date: Aug. 31, 2006

(54) Gasoline to pneumatic engine conversion zero emission & fuel cost

(76) Inventor: Rudolph V. Bailey SR., Manassas, VA (US)

Correspondence Address: RUDOLPH V. BAILEY SR., P.O. Box 221911, Chantilly, VA, 20153-1911, US

(21) Appl. No.: 11/394,800

(22) Filed: Apr. 1, 2006

Related U.S. Application Data
(63) Continuation-in-part of application No. 10/886,459, filed on Jul. 7, 2004.
(60) Provisional application No. 60/485,414, filed on Jul. 8, 2003.
(60) Provisional application No. 60/729,292, filed on Oct. 21, 2005.

(51) Int. Cl. F01B 29/04; B60L 11/12

(52) U.S. Cl. 60/370; 123/DIG. 7; 290/50

(57) ABSTRACT

An internal combustion gasoline engine can be converted to a pneumatic engine with zero harmful emissions and zero recurring fuel cost. This can be accomplished by converting DC battery power to AC current, and using the AC current to operate a hot compressed air device. A hot-air delivery system which can replace gasoline and spark plugs with heated pneumatic energy, which is delivered to the engine through pneumatic injector plugs, in accordance to engine firing order. As the engine compresses cold intake air, and it is mixed with the heated compressed air a violent reaction is achieved, this action drives the engine piston downward. When this process is repeated the engine crankshaft will rotate with speed and torque enough to cause an automobile to self propel along a surface.

### DESCRIPTION OF RELATED APPLICATIONS

This Application is a Continuation-in-part of CO-pending application Ser. No. 10/886,459 Filed on Jul. 7, 2004, which claimed benefit of Provisional Application Ser. No. 60/485,414 filed on Jul. 8, 2003, and was modified to be a Continuation-in-part of CO-pending Application Ser. No. 60/729,292 filed on Oct. 21, 2005.

### BACKGROUND OF THE INVENTION

This version of the invention is concerned with the field of pneumatic engines used in the transportation industry. More specifically this version of the invention is concerned with the field devices that can be used to convert the conventional internal combustion gasoline automobile engines to use heated pneumatic energy instead of gasoline and spark plugs, for normal operation. This invention covers all the components and parts of said conversion.

### PRIOR ART

Some attempts have been made to use pneumatic energy in toy cars as is exemplified in U.S. Pat. No. 6,006,517 pneumatic engine, issued to Chades D. Kownaski et, al on Dec. 28, 1999. Some use of combustible bottled gases such as propane has been used instead of gasoline, however no example has been found of any attempt to convert the present internal combustion gasoline automobile engine to a non-combustible reliable emission-free and safe pneumatic engine. Vehicles using Bottled gases such as propane are banned from bridges and tunnels because of the dangerous potentials for explosions and fire that they pose. There exist therefore a continuing need for other safe forms of energy that is pollution-free and in plenteous supply, and inexpensive, that can be used in the transportation industry, to offset the spiraling cost and dwindling supply of gasoline.

The present invention achieves its intended purposes, objects, and advantages through a new, useful and unobvious combination of methods steps and component elements, with the use a minimum number of functioning parts, at a reasonable cost to manufacture, and by employing only readily available parts.

### SUMMARY

The present version of the invention, which will be described in greater detail hereinafter, relates to the field of transportation devices. More specifically, this version of the invention is concerned with the improvement of the conventional internal combustion gasoline automobile engine, by converting it to a non-combustible, non-polluting energy source which is plenteous in supply and free, such as heated air. My version of the invention overcomes all of the shortcomings listed previously, in addition to novel aspects that will be described in detail herein after.

Described according to a typical embodiment the invention consist of installing a heated compressed air device, and a heated pneumatic energy delivery system to an automobile, which will replace gasoline and spark plugs with pneumatic plugs and air hoses, and air admittance valves. The hot-air manufacturing and delivery devices in the preferred embodiment are powered by 110 and 220-volts AC, from a DC to AC generator which is covered in CO-pending application Ser. No. 60/729,292 filed on Oct. 21, 2005. In the alternate embodiment the said devices are powered by 220volts AC, which is generated by the automobile, by adding a deep-cycle battery or batteries, and a second alternator to refurbish the added battery, or batteries, and a DC motor which operates a DC inverted to AC generator, which in turn supplies the said 220-volts. A 440-volt transformer can also be added, to larger vehicles and heavy duty equipment.

My version of the invention, resides not in any one of these features per se, but rather in a particular combination of all of them herein disclosed. It is distinguished from the prior art in this particular combination of all of its structures, for the functions specified.

In order that a detailed description of the invention may be better understood, and that the present contribution to the art can be more fully appreciated, additional features of the invention will be described hereinafter. It should be appreciated by skilled in the art that the conception and the disclosed specific methods, and structures, may be readily utilized as a basis for modifying or designing other structures, for carrying out the same purposes of the present invention. It should be realized by those skilled in the art that such equivalent methods and structures do not depart from the spirit and scope of the invention.

In this respect, before explaining at least one embodiment of the invention in detail, it is to be understood that the invention is not limited to the details of construction, and the arrangements of components, as set forth in the following description, or illustrated in the drawings. The invention is capable of other embodiments, and of being practiced and carried out in various ways. Also, it is to be understood that the phraseology and terminology employed herein, are for the purpose of description, and should not be regarded as limiting.

As such, those skilled in the art will appreciate that the conception, upon which this disclosure is based, may readily be utilized as a basis for designing of other structures, methods and systems for carrying out the several purposes of the present invention.

Further, the purpose of the foregoing abstract is to enable the U.S. Patent and Trademark Office, and the public generally, and especially the scientists, engineers and practitioners in the art, who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

Accordingly it is an important object of our version of the invention to provide a low-cost, easy-to-manufacture gasoline to pneumatic engine conversion package.

A further object of our version of the invention is to provide an easy-to-install, and easy-to-maintain gasoline to pneumatic engine conversion package.

Another object of our version of the invention is to offer to consumers the added benefit of house current and compressed air from their automobile, for outdoor projects, and also be a benefit in power outages.

A significant object of our version of the invention is to provide a light-weight, and quiet, and easy-to-market, gasoline to pneumatic engine conversion package.

An important object of our version of the invention is to offer a gasoline to pneumatic engine conversion package that can help to reduce worldwide green-house gas emissions, and help to slow down the recent trend of global warming that is melting the ice glaciers threatening our planet and our existence on it.

Furthermore it is a significant advantage of our version of the invention to present to the marketplace a gasoline to pneumatic engine conversion package, that will eliminate dangerous engine exhaust emissions that is harmful to humans and damaging to the environment.

Another advantage of our version of the invention is that human lives will be saved as less people will die from fires in a crash, and also from CO2 poisoning.

Additionally a very important advantage of our version of the invention is to offer to the public a gasoline to pneumatic engine conversion package, that will completely eliminate the spiraling cost of gasoline to the customers, and will result in a 100% fuel-cost-savings, to consumers.

Another advantage of our version of the invention is that consumers will save money on engine tune-up and repairs because spark plugs are eliminated, the elimination of spark plugs will also result in extend engine life.

A further advantage of our version of the invention is to present to the public a gasoline to pneumatic engine conversion package, that will help to stimulate the economy by leaving consumers with more money to spend on other goods and services.

A final but very significant advantage of our version of the invention is to help to ease the present and future energy shortages, and to alleviate our nation's dependence on imported oil.

For a better understanding of the invention, its operating advantages and the specific objects attained by its uses, references should be made to the accompanying drawings and descriptive matter in which there are illustrated preferred and alternate embodiments of the invention. The foregoing has outlined some of the more pertinent objects and advantages of the invention. These objects and advantages should be construed to be merely illustrative of some of the more prominent features of the present invention. Many other beneficial results can be attained by applying the disclosed invention in a different manner, or by modifying the invention within the scope of the disclosure. Accordingly, other objects and advantages, and a fuller understanding of the invention may be had by referring to the summary of the invention. And the detailed description of the preferred and alternate embodiments, in addition to the scope of the invention illustrated by the accompanying drawings.

### BRIEF DESCRIPTION OF THE DRAWINGS

The foregoing and other objects, features and advantages of the invention will become more fully understood from the following description of the preferred and alternate embodiments of the invention as illustrated in the accompanying drawings in which like reference characters refer to the same parts throughout different views. The drawings are not necessarily to scale, emphasis instead being placed upon illustrating the principles of the invention.

FIG. 1 is a schematic diagram and plan view of a gasoline to pneumatic engine conversion illustrating all components of the conversion package, in accordance with the present version of the invention.

FIG. 2 is a perspective view illustrating an example of an alternate mounting position of the hot-air canister, and the accelerator-pedal-linkage connection, to hot-air-regulator-lever, in accordance with the present version of the invention.

FIG. 3 is a schematic diagram and plan view of an alternate embodiment of a gasoline to pneumatic engine conversion package illustrating the addition of new components for a AC generator, for 110/220-volts facilitated by the automobile engine, in accordance with the present version of the invention.

FIG. 4 is the same as in FIG. 3 except it is for a 24-volt modification for large vehicles and heavy duty equipment, and the inclusion of a 440-volt transformer in accordance with the present version of the invention.

FIG. 5 is a partially sectional elevation view of a hot-compressed-air-device as it would appear in a tire well of a standard automobile, in accordance with the present version of the invention.

FIG. 6 is a partially sectional elevation view of a large hot-compressed-air device for larger vehicles in accordance with the present version of the invention.

FIG. 7 is a perspective view of a hot-air-delivery-system illustrating all component parts and their assembly positions, in accordance with the present version of the invention.

FIG. 7A is an alternate embodiment of a hot-air-delivery-system, in accordance with the present version of the invention.

FIG. 7B is an alternate embodiment of a hot-air-delivery-system, in accordance with the present version of the invention.

### DRAWING REFERENCE NUMERALS AND IDENTIFICATION

102 Original Tire Well in Auto
109 Spare Tire Hold-down Bolt
113 Conventional Air-pump
117 Sound Proof Cover
118 Conventional Shut-off Valve
123 Adjustable Legs
124 Temperature and Pressure Relief
126 Thermostat Control & Switch
127 Motor On/Off Switch
128 Conventional Pressure Gauge
129 Air-hose Snap-On Connection
131 Conventional Pressure Control
132 220-volt Pump Motor
134 440-volt Pump Motor
135 Holding Tank
136 Holding Tank
138 Existing Bed of Automobile
301 Non-conductive Thermal Spacers
333 12 or 24-volt electric magnet
334 220-volt Power Cord with twist-lock Plug to Pump Motor Control
335 220-volt Power Cord with twist-lock Plug to Tank Heating Coil
336 Permanent Magnet
337 Tension Spring
340 Existing Spark-plug Wires
342 Air Pressure Regulator with Lever for Pedal Assembly
348 110-volt Power Cord from Hot-air-distributor Heating-coil
352 Existing Engine Block
353 Existing Carburetor/Air-cleaner Case
356 Existing Distributor with Main Wire
362 Intake to Hot-air Delivery System
364 Rubber Grommet
367 Jacketed Compressed Thermal Insulation
368 Heating-coil Thermostat Control
370 Temperature and Pressure Relief
372 Air Outlet
376 Connection for Spark Plug
377 EZ12 Air-admittance Valves
378 Temperature & Pressure Taps
380 Instrument-dash Temperature & Pressure Gauge
382 Bracket Mounting Plate
386 Vertical Drain Plug
388 Canister Cover & Gasket
389 110 or 220-volt-AC Heating Coil
390 Cover Hold-down Bolts
392 Regulator Adjusting Screw
394 Hot-air-distributor Canister
396 Accelerator Pedal
397 Mounting Hardware
398 Accelerator Linkage Connection
400 Power Cord to Motor Controls with Twist-lock Plug for 440-volt AC
402 Power Cord to Heating Coil with Twist-lock Plug for 220-volt AC
406 Carburetor Canister Cover
408 Carburetor Type Hot-air-distributor
410 Carburetor Air-intake
460 Drain Hose
462 Air Intake Hose
464 Rubber Spacer
465 Collar Nut to Fit Air-admittance Valve
468 Access Cover with High Temperature Gasket
470 Air-filter
472 Sound-proof Cover
474 Conventional 2-stage Air-pump
478 Tank Heating Coil
480 Jacketed Thermal Insulation
482 Tank Heating Coil
484 ‘O’ Ring Rubber Seal
485 Nut Collar to fit ⅝″ Spark-plug Socket
486 Threaded to match Engine-block for original Spark-plug
487 Spiral Internal Flutes to cause air to rotate counter-clock-wise
488 Snap on type Hose connector
490 Insulated Thermal Air-hose
492 Circuit-breaker Box with twist-lock receptacles for 110/220-volt-AC
493 Circuit-breaker Box With twist-lock receptacles for 110/220/440-volt-AC
494 Original 12 or 24-volt main wire to auto fuse box
496 Motor Switch connected Engine Starter Switch
500 Wire to 220-volt-AC Heating Coil for Device 20B
777 Pneumatic Injector Plug
(A) 12-volt Automobile Type Alternator
(A)2 24-volt Automobile Type Alternator
(B) 12-volt Deep-cycle Battery
(B)2 12-volt Deep-cycle Battery (in series for 24-volts)
(M) 12-volt-DC Variable Speed Continuous Operating Motor
(M)2 24-volt-DC Variable Speed Continuous Operating Motor
(P) Double Pulley
(T) 220/440-volt-AC Transformer

### DESCRIPTION OF THE PREFERRED EMBODIMENT DESCRIPTION

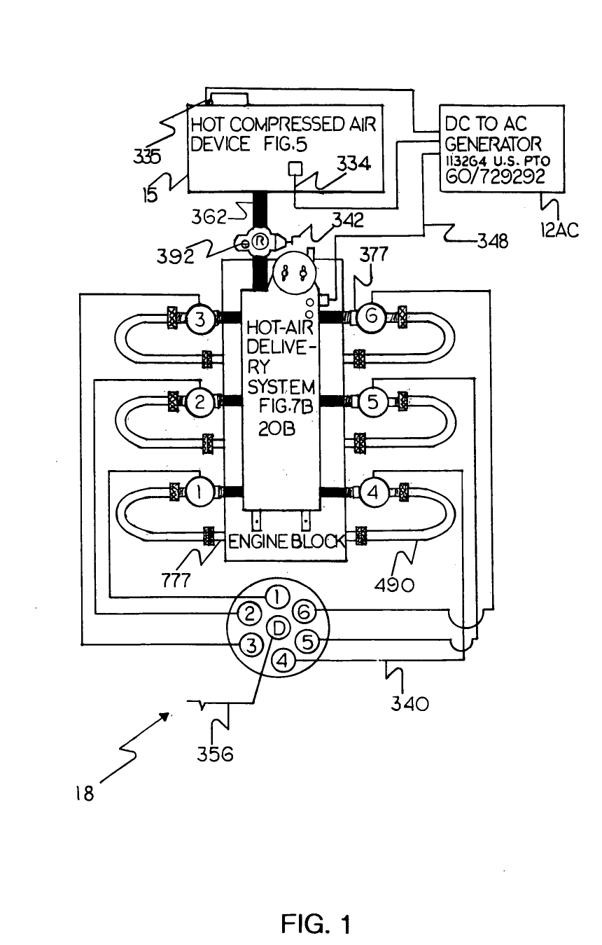

Referring now to the drawings and, in particular to FIG. 1 wherein there is illustrated a typical embodiment of a gasoline to pneumatic engine conversion package with zero damaging emissions and zero recurring fuel cost 18. The present version of the invention 18 illustrates all of the components for the said conversion package. DC to AC electric generator 12AC which is covered in CO-pending application control No. 60/729,292, and not a part of this application, supplies 110 & 220-volts to operate said conversion package. Heated compressed-air device 15 is used to supply the hot compressed-air which will be used instead of gasoline and spark-plugs to operate the engine.

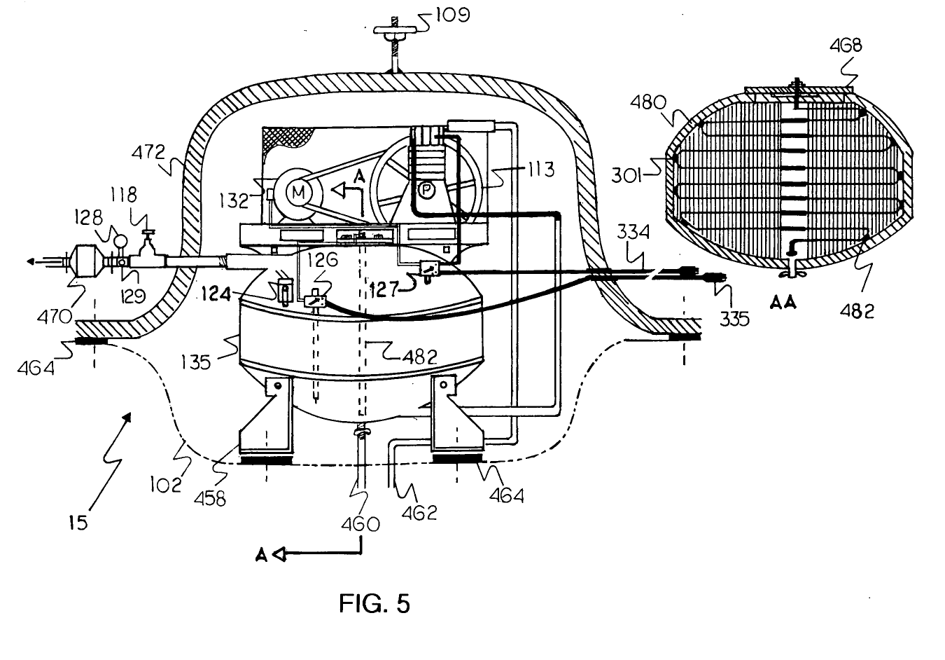

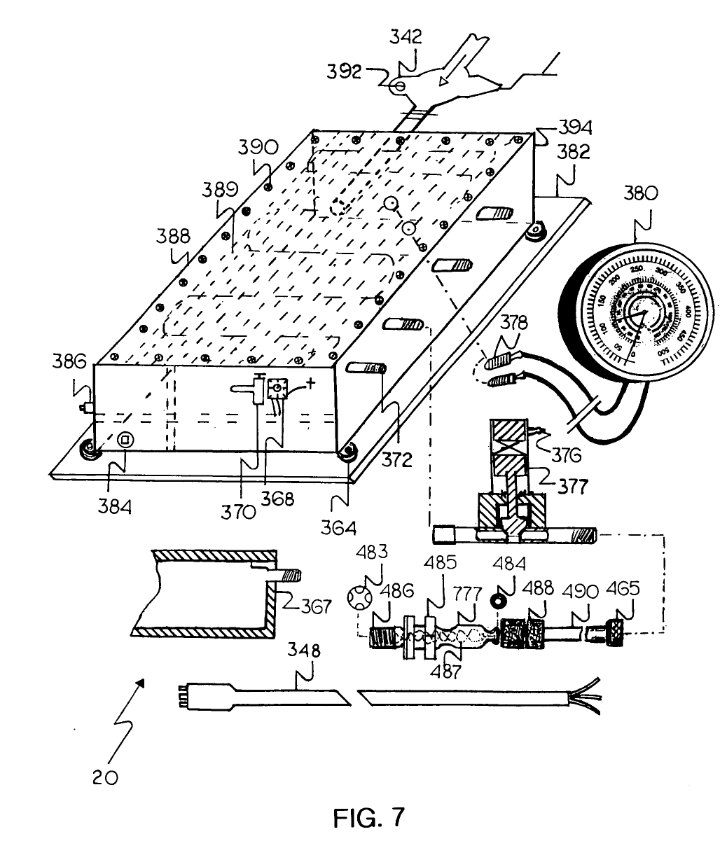

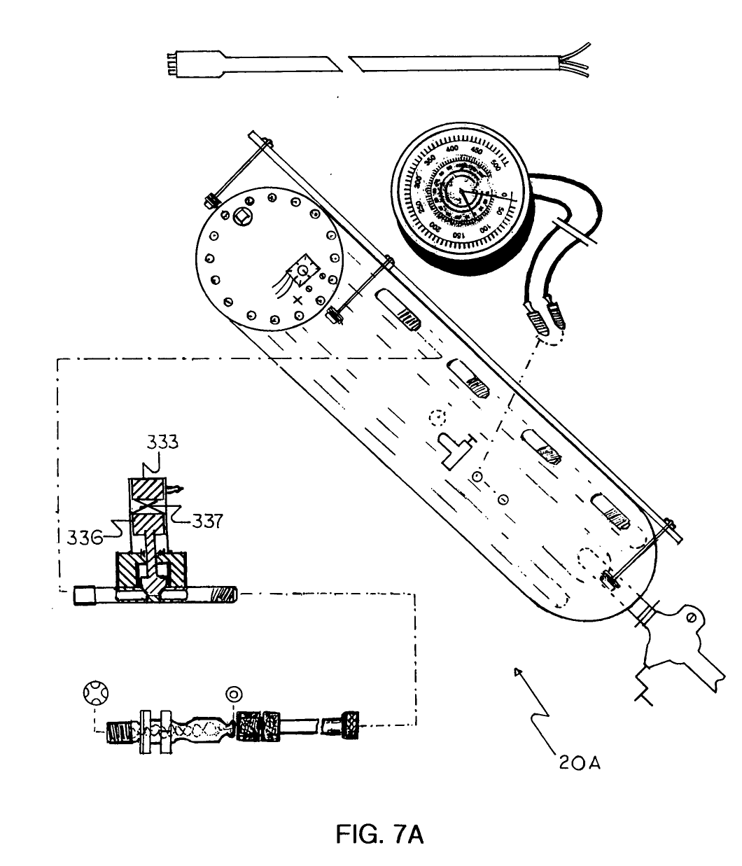

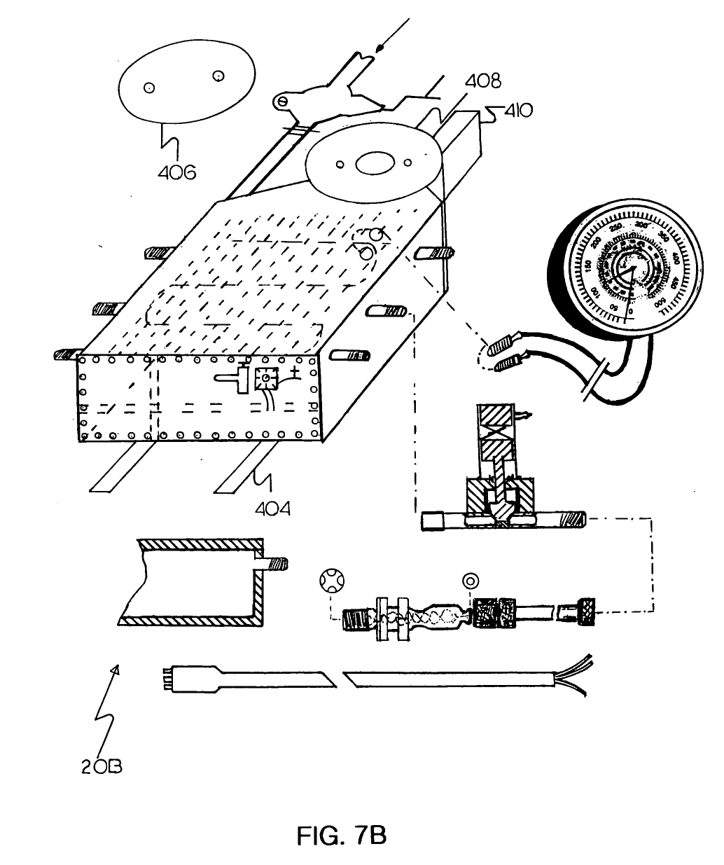

Hot-air delivery system 20B, FIG. 7B stores and re-heats a smaller amount of compressed-air at a lower pressure than the main storage tank on device 15. This lower pressure which is slightly above the engine compression, will provide the engine idle-pressure and is set by adjusting regulator 342, at adjusting screw 392. Air-admittance valve 377 allows original spark-plug wires to be attacked to it. Insulated hose 490 is then attached to valve 377, and air-injector plug 777, is installed in original spark plug taped-port in engine block. Temperature and pressure gauge 380, (FIG. 5) should be installed to hot-air delivery system as indicated in FIG. 7, and to instrument panel inside of vehicle. The high energy coil should be removed and the gas tank should be drained, and the line should be capped.

To operate engine plug power cords to portable generator 12AC. Allow compressor to pressurize holding tanks. Allow heating elements to bring compressed-air to operating temperature. Gage 380 will indicate normal temperature and pressure range. Start engine in normal way, as engine compresses cold intake air in each cylinder, air admittance valve 377 will send a blast of high pressure and temperature air to each cylinder in response to engine firing order. The mixing of hot-compressed-air and the cold-engine-compressed-air causes a violent reaction which drives the engine piston downward. As the said action is repeated according to engine's original timing order, the engine should idle in the normal way.

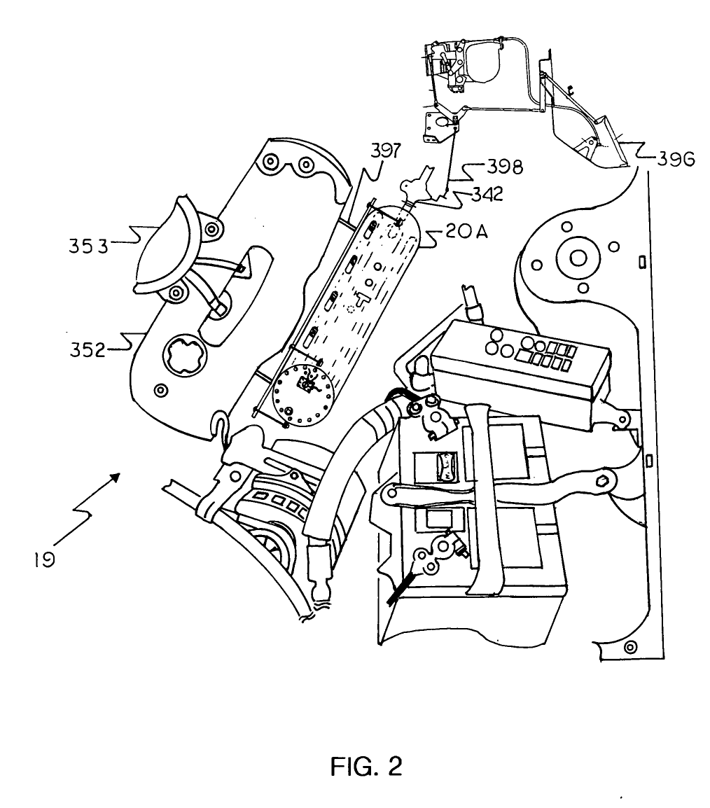

Referring now to FIG. 2 illustration 19 which shows a cylindrical hot-air delivery system 20A side mounted to engine block 352, also illustrated is accelerator pedal 396 and linkage arrangement assembly 398 connected to air-regulator 342. When accelerator pedal is depressed air regulator 342 will increase pressure to hot-air delivery system 20A or B, thereby increasing engine speed. This version of the invention is ideal for converting existing engines already in use.

### DESCRIPTION OF THE ALTERNATE EMBODIMENT

Description

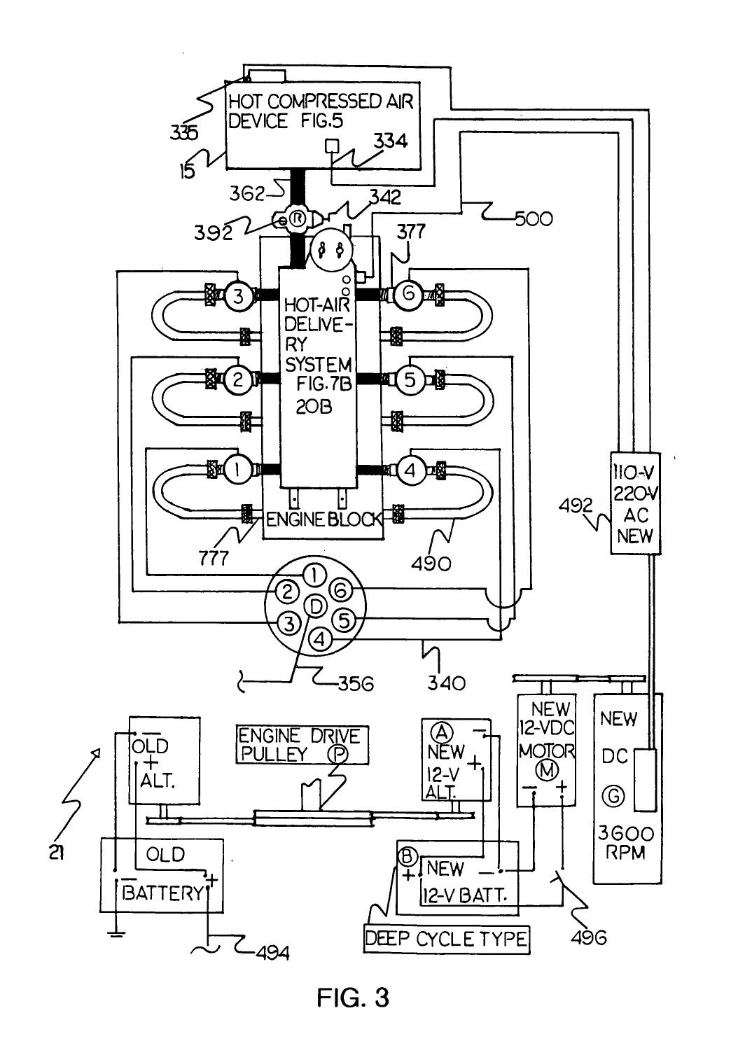

Referring now to FIG. 3 wherein there is illustrated an alternate embodiment of a gasoline to pneumatic engine conversion package 21. The present version of the invention 21 does not use the external portable DC to AC electric generator 12AC as in FIG. 1. Instead slight modifications are made to the engine to supply the AC current needed to operate the conversion package. Accordingly this version of the invention is more suited to be incorporated in new engine design but can also be done to an existing engine. A double pulley (P) can be installed on the original alternator drive shaft as illustrated, and a new alternator (A) can be added to the engine. A new battery (B) would also be added, which could be placed in the trunk with the other components, or any other convent location. The new battery (B) would be a deep cycle type, and would be used to operate a DC motor (M). The said DC motor would operate a DC inverted to AC generator (G) at a speed of about 3600-RPM. The said generator (G) would supply 110/220-volt-AC. The said AC current would go to a circuit-breaker box 492, with twist-lock receptacles for 110/220-volt-AC. In this version of the invention, the air-compressor and heating coils would use 220-volts, with a 110-volt spare receptacle which could be used for other things. ON/OFF switch 496 would be wired to the engine start switch.

To operate the engine once the conversion is completed as explained earlier in FIG. 1 and FIG. 2, the air-storage tanks must be pressurized by a separate air-compressor in this version of the invention. Since the engine must supply the electrical energy needed to provide the heated pneumatic energy, we must start with fully pressurized tanks. The air-compressor 15 would only need to replace the compressed-air used to operate the engine. To start the engine turn the ignition key to the on position but do not crank the engine. This will cause motor (M) and the generator (G) to operate, wait until the proper compressed-air temperature is indicated on instrument gauge 380 (FIG. 5). When this is achieved crank engine, and operate as previously explained. The new alternator (A) will refurbish new battery (B) as the engine operates in a normal fashion.

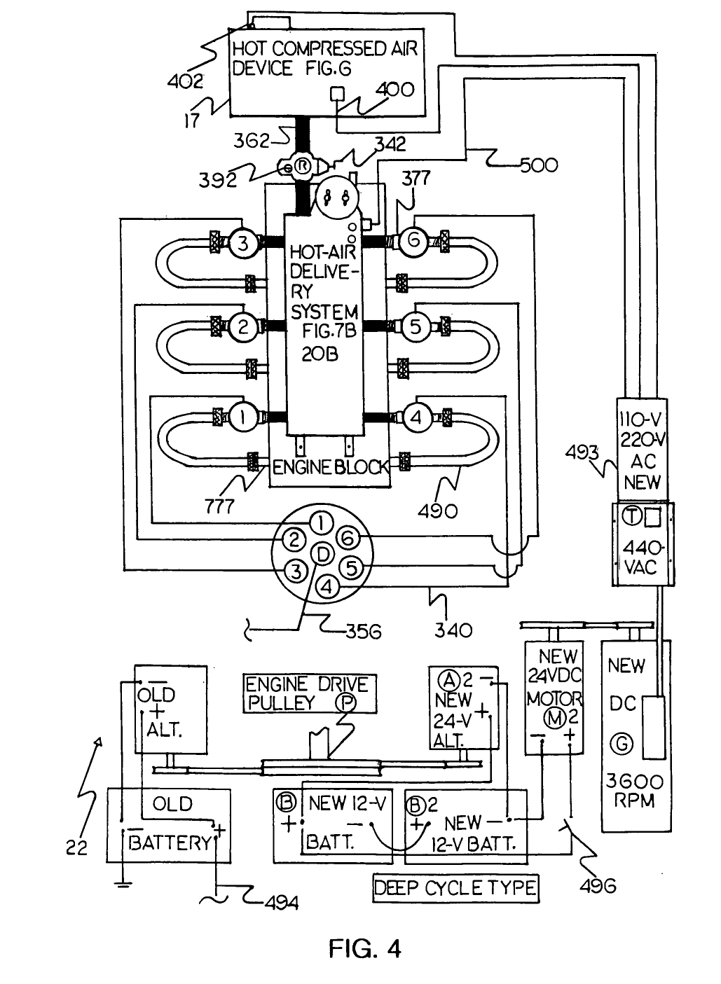

Referring now to FIG. 4 wherein there is illustrated a alternate embodiment of a gasoline to pneumatic engine conversion package 22. The present version of the invention 22 operates on the same as in FIG. 3, except that two new 12-volt deep-cycle batteries B & B2 are connected in series to give 24-volts. A new 24-volt alternator A, is also added to refurbish said batteries. In addition a 24-volt-DC motor (M) is added and is used to operate a DC inverted to AC generator as in FIG. 3. A 440-volt transformer is also added so that 110/220/440-volts can be achieved. Hot-compressed-air device 17 drive motor is operated by 440-volt-AC. The heating coils on device 17, and 20B uses 220-volts, with a 110-volt spare receptacle as in FIG. 3. Circuit breaker box 493 has twist-lock receptacles for 110/220/440-volt-AC. Invention 22 is for larger engines for large vehicles, and heavy duty equipment.

Referring now to FIG. 5 wherein there is illustrated a typical embodiment of a hot-compressed-air 15. The present version of the invention 15 is constructed of materials and components that are light weight and durable, and resistant to corrosion and oxidization such as aluminum, fiberglass, plastic, stainless steel, mild steel, various composite materials, or a combination thereof. The invention presents a conventional type air compressor, modified in the following ways, for a new use, as an improvement of an existing product: The pump motor 132, and the air-pump 113 are made of light weight materials, and built to low-noise standard. The air storage tank 135 is jacketed, and compressed with blow-in type thermal insulation giving tank 135 a thermos effect to minimize heat lost. Tank 135 also has access opening and cover 468 with high temperature gasket. Said opening is large enough to allow tank heating coil 482 which is assembled to cover 468, to fit through said opening. Heating coil 482 has non-conductive spacers assembled to it, to prevent said coil from making contact with inner surface of tank 135. Thermostat 126 controls the ON/OFF operation and temperature of coil 482. Temperature and pressure relief 124 protects tank 135 as a safety control. Air-hose Snap-On connection is provided to pressurize tank if needed and as a connection for extra work or hobbies if needed. Air-filter 470 removes any residue that may be in tank 135. The invention 15 shows how it would be installed in tire-well 102, in trunk of conventional automobile. soundproof cover 472 should be sturdy enough so that a doughnut spare tire can be bolted on top, with spare tire hold-down bolt 109. Cover 472 can be made to fit to floor if applicable. When installed holes should be made on the floor in tire well to facilitate drain-hose 460 and air-intake hose 462, extra holes should be made in floor to allow motor 132 to be ventilated.

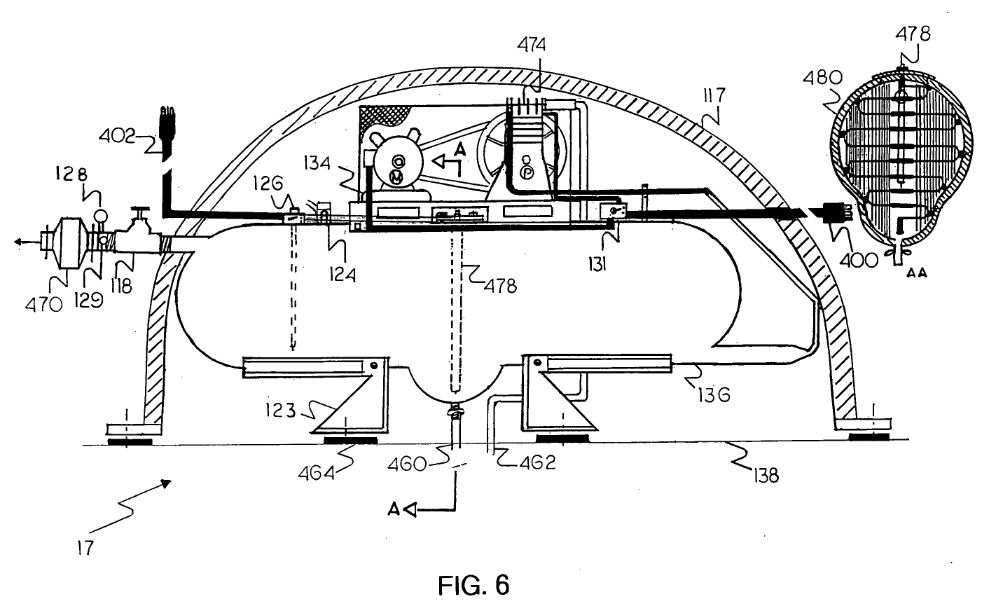

FIG. 6 is the same as FIG. 5 except that the drive motor 134 operates on 440-volts and air-pump 474 and storage tank 136 is for lager capacity and higher pressure, and is for larger vehicles.

Referring now to FIG. 7 wherein illustrated is a typical embodiment of a hot-air delivery system 20. The present version of the invention 20 is constructed of materials that are light weight where possible, but durable and strong enough to withstand high temperature and pressure. Said materials should also be resistant to corrosion and oxidization, such as stainless steel, fiberglass, carbon and mild steel, brass, copper, plastic, composite materials or a combination thereof. The device 20 consist of a hot-air distribution canister 394 which is jacketed and compressed with thermal insulation 367. Canister 394 has out-put ports 372 near top, for any number of cylinders, and input port near bottom to receive air-regulator 342, with pressure adjusting screw 392. Outlet ports 372 is threaded to receive air-admittance valve 377, with push-on connection 376, to receive engine spark-plug wire. The other end of valve 377 is threaded to mate seal-tight with insulated high temperature and pressure air-hose 490. The other end of hoes 490 has Snap-On connector with thermal ‘O’ seal and mates air-tight to air-injector plug 777. Plug 777 has internal spiral flutes 487 to cause air to spin in a counter-clockwise rotation as it exits the plug through four orifices as shown. The other end of plug 777 is threaded to fit spark-plug port in engine block for the engine being converted, and collar 485 should be made to fit the appropriate spark plug socket.

Hot-air canister 394 has heating coil 389 for either 110 or 220-volts depending on the conversion package. A pressure and temperature relief 370 and a thermostat 368 is included. Base mounting plate 382 is separated with grommets 364 to prevent mounting plate to draw heat from canister. Drain port 384, allows inlet from either end, the alternate end would be the drain port. Canister cover 388 is jacketed and filled with compressed thermal insulation and installed air-tight with gasket seal and appropriate hardware and pressure tested at twice the working pressure. Ports 372 should also be insulated, as well as all exposed tubing or piping and valves. Electrical power cord 348 should have twist-lock plug and connected in accordance with proper code. FIGS. 7A and 7B are alternate embodiments and operates on the same principles.

Ramification Conclusion and Scope of the Invention

From the foregoing it will be understood by persons skilled in the art that an invrovement of an existing product has been disclosed, the conversion of the internal combustion gasoline engine, to an emission free pneumatic engine, with no recurring fuel cost, has been provided. The invention is relatively simple and easy to manufacture, yet affords a variety of uses, benefits, objects and advantages. The invention solves present problems related to the gasoline engines, for example the run-away cost of gasoline, and the practice of price-gouging in emergencies, like in hurricane katrina, which sent gasoline prices through the roof so to speak. Our conversion package eliminates the recurring cost of fuel, since our pneumatic engine conversion operate on free-air. Spent gasoline is a leering cause of green-house-gas emissions which is the cause of global warming and other heath related problems associated with air pollution, which threatens humans and our planet's continued existence. A list of object and advantages on pages 5-7 of our summary, gives compelling reasons for the invention to be granted as soon as possible, for which the applicant petitions the examiner. While the main use of gasoline is for transportation devices, in land, air and to a lesser degree sea-bound crafts, the conversion now gives new application for the internal combustion engine once converted. For example it can be used to generate electricity in residential, commercial, industrial, and in power plants and many other applications. Since said converted engine has no polluting emissions it can be used indoors, and since it gives virtually free energy it is invaluable as a machine in industrial applications like to operate air-pumps, generators and such like.

Furthermore numerous modifications of the invention will readily occur to persons skilled in the art, it should be realized that the purpose of this application is merely to demonstrate the principles of the present invention, and all such relevant uses and modifications fall within the spirit and scope of the invention. Although this invention has been described in the preferred and alternate forms with a certain degree of particularity, it is understood that the present disclosure of the preferred and alternate forms has been made only by way of example, and numerous changes in the details of construction and combination and arrangement of parts may be resorted to without departing from the spirit and scope of the invention. Although the drawings and specifications may list certain values of volts, RPM, types of battery, or generator or such like, those values may be changed to any other values that may prove to work better, or be more suitable without departing from the spirit and scope of the invention.

1. What I claim is the new unforeseen and unintended use of the following prior art components to accomplish the conversion of the conventional internal combustion gasoline automobile engine to a non-fuel burning emission free pneumatic engine comprising:
(a) 12-volt-DC deep cycle marine type batteries and
(b) 12-volt automobile type alternators and
(c) 24-volt automobile type alternators and
(d) 12-volt-DC continuous operating motors and
(e) 24-volt-DC continuous operating motors and
(f) DC inverted to AC generators and
(g) 220 to 440-volt-AC transformers
whereby when said major component parts are assembled as in dependent claim No. (1) the purposes of independent claim (1) can be realized.
